(19) United States
(12) Patent Application Publication
(10) Pub. No.: US 2019/0230768 A1
(43) Pub. Date: Jul. 25, 2019

(54) LIGHTING CONTROL

(71) Applicant: SIGNIFY HOLDING B.V., EINDHOVEN (NL)

(72) Inventors: Antonie Leonardus Johannes KAMP, EINDHOVEN (NL); Paulus Maria Johannes OPPENEER, EINDHOVEN (NL); Dzmitry Viktorovich ALIAKSEYEU, EINDHOVEN (NL); Aloys HUBBERS, EINDHOVEN (NL)

(21) Appl. No.: 16/330,661

(22) PCT Filed: Sep. 11, 2017
(86) PCT No.: PCT/EP2017/072678

§ 371 Date: Mar. 5, 2019

(30) Foreign Application Priority Data
Sep. 12, 2016 (EP) 16188253.5

(51) Int. Cl. H05B 37/02; G05B 15/02

(52) U.S. Cl. CPC H05B 37/0218; H05B 37/029; G05B 15/02; H05B 37/0272

(57) ABSTRACT

According to one aspect disclosed herein, there is provided a method of controlling a plurality of luminaires to illuminate an environment, the method comprising steps of: determining a lighting pattern to be rendered by the plurality of luminaires, the lighting pattern comprising a respective lighting setting for transmission to each of the plurality of luminaires; accessing a memory storing a lighting function which, as stored in the memory, defines concurrently for a set of some or all of said plurality of luminaires respective lighting setting modifiers to be applied to the respective lighting settings for the respective luminaires of said set, wherein said accessing comprises retrieving the lighting function from the memory; applying the lighting function to the lighting pattern to generate a modified lighting pattern comprising respective modified lighting settings for the plurality of luminaires, by applying the lighting setting modifiers to the respective lighting settings in order to generate the respective modified lighting settings for said luminaires of said set; and controlling the plurality of luminaires to render the modified lighting pattern, by controlling the luminaires of said set in accordance with the respective modified lighting settings and controlling other ones of said plurality of luminaires not in said set in accordance with the respective lighting setting; wherein the lighting function is such that at least some of the defined lighting setting modifiers are different.

### TECHNICAL FIELD

The present disclosure relates to systems and methods for controlling lighting devices to render a lighting scene in an environment.

### BACKGROUND

Electronic devices are becoming ever more connected. A “connected” device refers to a device—such as a user terminal, or home or office appliance or the like—that is connected to one or more other such devices via a wireless or wired connection in order to allow more possibilities for control of the device. For instance, the device in question is often connected to the one or more other devices as part of a wired or wireless network, such as a Wi-Fi, ZigBee or Bluetooth network. The connection may for example allow control of the device from one of the one or more other devices, e.g. from an app (application) running on a user device such as a smart phone, tablet or laptop; and/or may allow for sharing of sensor information or other data between the devices in order to provide more intelligent and/or distributed automated control.

In recent years, the number of connected devices has increased dramatically. Lighting systems are part of this movement towards a connected infrastructure. Conventional connected lighting systems consist of fixed light sources, which can be controlled through wall-mounted switches, dimmers or more advanced control panels that have pre-programmed settings and effects, or even from an app running on a user terminal such as a smart phone, tablet or laptop. For example, this may allow users to create an ambiance using a wide range of coloured lighting, dimming options and/or dynamic effects. In terms of control the most common approach is to replace a light switch with a smartphone based app that offers extended control over lighting (for example Philips hue, LIFX, etc.).

A lighting scene (also called a lighting pattern) is a particular overall lighting effect in an environment rendered by the light sources in that environment. E.g. a “sunset” scene may be defined in which the light sources are set to output hues in the red-yellow range of the visible spectrum. Each light source may for example output the different hues (or other setting such as saturation or intensity), or a scene may be rendered by all (or some) lights rendering a single colour or similar colours. Note that lighting scenes may be dynamic in that the output of one or more light source changes over time.

### SUMMARY

One of the new possibilities of a home connected lighting system is to use it as part of a home entertainment setup. However, a typical home lighting setup is not made specifically for entertainment purposes and strongly varies per setup. This means that by default, the lighting effects at one location in the entertainment setup may be too intense and distracting, white in another location it may be hard to notice and underwhelming. This has to do with the perceived light intensity of the lights and other light sources like a TV.

The present invention proposes a system which translates a generic lighting input, to a lighting output which is specific for a certain location. This is done based on a location dependent equalizer (a “lighting function”) which can be adjusted to tune the light intensity at different locations.

According to a first aspect disclosed herein, there is provided a method of controlling a plurality of luminaires to illuminate an environment, the method comprising steps of: determining a lighting pattern to be rendered by the plurality of luminaires, the lighting pattern comprising a respective lighting setting for transmission to each of the plurality of luminaires; accessing a memory storing a lighting function which, as stored in the memory, defines concurrently for a set of some or all of said plurality of luminaires respective lighting setting modifiers to be applied to the respective lighting settings for the respective luminaires of said set, wherein said accessing comprises retrieving the lighting function from the memory; applying the lighting function to the lighting pattern to generate a modified lighting pattern comprising respective modified lighting settings for the plurality of luminaires, by applying the lighting setting modifiers to the respective lighting settings in order to generate the respective modified lighting settings for said luminaires of said set; and controlling the plurality of luminaires to render the modified lighting pattern, by controlling the luminaires of said set in accordance with the respective modified lighting settings (and, if some of the plurality of luminaires are not in said set, continuing to control the other ones of said plurality of luminaires not in said set in accordance with the respective lighting setting); wherein the lighting function is such that at least some of the defined lighting setting modifiers are different.

In embodiments, each of the lighting setting modifiers defined by the lighting function is associated with at least one respective physical region within the environment, and wherein said applying of the lighting setting modifiers to the respective lighting settings comprises: mapping respective ones of the set of luminaires to said regions; and applying each lighting setting modifier to a lighting setting being for transmission to a respective luminaire which is mapped to the same region as that lighting setting modifier.

In embodiments, the region to which a luminaire is mapped according to said mapping is the region in which the luminaire is located.

Alternatively, the region in which a luminaire is mapped according to said mapping is the region in which an effect cast by the luminaire is located. This is particularly advantageous for luminaires which generate lighting effects which are not necessary substantially co-located with the luminaire itself (e.g. a spotlight). Hence, it is understood that this mapping of effect locations to regions is preferably performed at least for ones of the luminaires which are of a type which generate lighting effects which are not substantially co-located with the luminaire.

In embodiments, each of the lighting setting modifiers defined by the lighting function is associated with at least one respective physical region within the environment, and wherein said applying of the lighting setting modifiers to the respective lighting settings comprises: determining, for each respective one of the set of luminaires, in which of the regions the respective luminaire is located or which of the regions is illuminated by the respective luminaires; and applying the lighting setting modifier for that determined region to the respective lighting setting for said respective one of the set of luminaires.

In embodiments, the lighting function is stored in memory concurrently defining the respective lighting setting modifiers for luminaires before the lighting pattern is determined.

In embodiments, the lighting function is selected by a user. For example, by input from a user device.

In embodiments, the lighting function comprises a first part defining lighting setting modifiers for a first set of the plurality of luminaires and a second part defining lighting setting modifiers for a second set of the plurality of luminaires, said second set non-overlapping with the first set; wherein the method further comprises: a user (309) selecting the first part of the lighting function and the first set of the plurality of luminaires; and selecting the second part of the lighting function and the second set of the plurality of luminaires. The second part of the lighting function and the second set of the plurality of luminaires may be selected by the same used as the first part and first set, or may be selected by a different user other than the user who selected the first part and first set.

In embodiments, the lighting pattern is determined based on user input received from a user, and wherein the respective lighting setting modifiers of said lighting function are defined by said user.

In embodiments, the lighting pattern is determined based on user input received from a user, and wherein the respective lighting setting modifiers of said lighting function are defined by a different user other than said user.

In embodiments, the lighting pattern is determined by being retrieved from a memory storing the lighting pattern.

In embodiments, the method further comprises steps of: determining a second lighting pattern to be rendered by the plurality of luminaires; applying the same lighting function to the second lighting pattern to generate a modified second lighting pattern; and controlling the plurality of luminaires to render the modified second lighting pattern.

In embodiments, said plurality of luminaires is a 2D spatial array of luminaires in Cartesian coordinates. That is, a two dimensional array of luminaires within the environment such as a square, rectangular, hexagonal or other regular or non-regular two dimensional grid or arrangement of luminaires which forms a flat plane. In this case the lighting function may be called a mask, or layer in that it defines respective lighting setting modifiers to be applied to the two dimensional array of luminaires.

In embodiments, said plurality of luminaires is a 3D spatial array of luminaires in Cartesian coordinates. That is, a three dimensional array of luminaires within the environment such as a cube, cuboid, tetrahedral or other regular or non-regular three dimensional grid or arrangement of luminaires. In this case the lighting function may be called a mask or filter in that it defines respective lighting setting modifiers to be applied to the three dimensional array of luminaires.

In embodiments, the lighting pattern comprises a respective first layer lighting setting for each of the plurality of luminaires and a respective second layer lighting setting for each of the plurality of luminaires; and wherein said lighting function defines a respective first layer lighting setting modifier to be applied to the respective first layer lighting setting and a respective second lighting setting modifier to be applied to the respective second layer lighting setting.

In embodiments, the lighting pattern comprises a respective first layer lighting setting for each of the plurality of luminaires; a respective second layer lighting setting for each of the plurality of luminaires; and a respective third layer lighting setting for each of the plurality of luminaires; wherein said lighting function defines a respective first layer lighting setting modifier to be applied to the respective first layer lighting setting; a respective second lighting setting modifier to be applied to the respective second layer lighting setting; and a respective third layer lighting setting modifier to be applied to the respective third layer lighting setting.

In embodiments, the number of lighting setting layers and respective lighting setting modifiers if four or more.

In embodiments, the method further comprises steps of determining at least one additional lighting effect generated by at least one additional light source within the environment other than said plurality of luminaires, and wherein the respective lighting setting modifiers of the lighting function are such that the modified lighting pattern, as rendered within the environment, is substantially the same as said lighting pattern would have been if said at least one additional lighting effect was not present within the environment.

In embodiments, at least two of said set of luminaires are such that they render a same lighting setting differently, and wherein the respective lighting settings modifiers for said at least two of said set of luminaires are such that said same lighting setting is rendered equally by each of said at least two of said set of luminaires.

According to a second aspect disclosed here, there is provided a controller arranged to perform the method according to the first aspect or any embodiments thereof.

According to a third aspect disclosed herein, there is provided a system comprising the controller according to the second aspect and the plurality of luminaires.

According to a fourth aspect disclosed herein, there is provided a computer program product comprising code stored on a computer-readable storage medium arranged so as when executed by one or more processing units to perform the method according to the first aspect or any embodiments thereof.

### BRIEF DESCRIPTION OF THE DRAWINGS

To assist understanding of the present disclosure and to show how embodiments may be put into effect, reference is made by way of example to the accompanying drawings in which:

FIG. 1 shows a system according to embodiments of the present invention;

FIG. 2 is a functional block diagram of a controller according to embodiments of the present invention;

FIG. 3 is a method performed by the controller in accordance with embodiments of the present invention;

FIG. 4 shows the modification of individual lighting settings by a lighting function;

FIG. 5A-5B show examples of graphical user interfaces;

FIGS. 6A-6B show further examples of graphical user interfaces.

### DETAILED DESCRIPTION OF EMBODIMENTS

A typical home lighting setup is not made specifically for entertainment purposes and strongly varies per setup. An entertainment (e.g. game or movie) developer will normally create generic light content which defines light effects on certain locations. This generic content cannot take into account what the perceived light intensity at a certain location will be for a specific setup, because this depends on many factors. For example, this may depend on one or more of the following:

the amount and type of lights at that location;

the amount and type of lights at other locations;

the way the lights are directed;

whether lights are in a luminaire and what kind of luminaire;

the colour of surroundings like walls;

the intensity of other sources of light pollution which are not necessarily part of the lighting network, such as a TV; and/or

light in the room from other sources.

Furthermore, a user will have a personal preference for what light intensity at which locations gives the user the best lighting experience. This may even depend on things such as the user's mood, the time of day, the specific entertainment content being used, or a combination thereof.

The result of all the above-mentioned factors is that by default, the lighting effects in a specific entertainment setup may not be suitably balanced. For example, the lighting effect may be too intense and distracting at one location, while at another location it may be hard to notice and underwhelming. This may degrade the user's experience to varying degrees.

The present invention solves this problem by translating a generic light control input (e.g. generated by an application such as an entertainment application) to an adjusted light control output, where the adjustment is specific for a certain location within an environment. This is done by providing a location based light equalizer (also called a “lighting function”), where a user can select different intensity factors for different locations in an entertainment setup. Preferably, the system then: 1) detects the light intensity of incoming light commands for each location; 2) adjusts the intensity based on a location specific intensity factor for each location, as defined in the location based light equalizer; and 3) render outgoing light commands per location based on this adjusted intensity.

In one embodiment, the lighting function comprises brightness multiplication factors to be applied to the lighting settings. That is, the system just multiplies the brightness attribute for every luminaire's lighting setting with a multiplication factor set for that luminaire (e.g. by location with the environment).

However, perceived light intensity depends not only on brightness but also light properties such as color, saturation, dynamic range and effect speed. Hence, in further embodiments, the system can implement a more advanced filter, i.e. a more advanced lighting function, which makes effects more or less intense using a combination of these factors. This filter can be adjusted based on a single intensity parameter. Alternatively, an advanced user or commissioner could tune these properties individually.

In general, the lighting function may comprise “lighting setting modifiers” to be applied to lighting settings to generate modified lighting settings. As mentioned above, the lighting setting modifiers may be multiplications factors of the brightness, or may also be an absolute change (i.e. a delta) to be applied (e.g. +50 lumens, −30 lumens, etc.). The lighting setting modifiers may also be applied to other light properties. For example, a lighting setting modifier may define multiplication factors for separate red, green, and blue channels in a color space. As a further example, a lighting setting modifier may define a speed or delay to be applied to the lighting setting. That is, a lighting setting modifier may, for example, be a multiplication factor to be applied to a “rendering time” being a time over which the lighting setting is rendered. Similar multiplication factors may be applied to other light properties such as saturation.

A lighting setting modifier may not be a simple multiplication factor but may also defined changes to be made to the lighting settings in other ways. For example, other mathematical operations such as addition, subtraction, powers, roots, exponentiation, logarithms etc. Which operation or combination of operations is used may depend on the specific implementation as each has its advantages and disadvantages.

For example, one downside of just multiplying is the effect of clipping. With too much boost, all luminaires will be on full brightness such that intended brightness variation of lights are no longer realised. To overcome this problem, the boosting/attenuation can be done relative to the original lighting setting (e.g. brightness level).

As an illustrative example, a modifier of 0 may mean no effect to the original brightness, −10 is the largest attenuation and 10 is the largest boosting value. If there are two lights in the original lighting setting where luminaire A is at 10% brightness and luminaire B is at 70% brightness. That means that for luminaire A, the lighting function maps −10 to 0linear to 0-10% and 0 to 10 linear to 10-100%. Whereas for luminaire B, the lighting function maps −10 to 0 linear to 0-70% and 0 to 10 linear to 70-100%.

In even more advanced embodiments, the lighting setting modifier can be implemented relative to the average of a dynamic lighting setting over time. E.g. if a luminaire (or a whole scene) is on average more dark in a certain scene (e.g. a level of a video game being played on a TV) then it can be boosted more than a luminaire or whole scene which is already very bright over time.

Further still, other variables such as the time of day can be used to make the lighting function itself dynamic. That is, the lighting function which modifies the lighting settings can be a function of time. In these cases, the lighting function defines concurrently respective lighting setting modifiers, as described herein, for two or more different times such as times of day. Therefore, the lighting setting modifiers applied to the lighting settings change through time. For example, the lighting function may define a first lighting setting modifier to be applied during the morning and a second lighting setting modifier to be applied during the evening.

In lighting systems, the brightness of a luminaire can be defined either as a percentage (e.g. a percentage of the maximum output brightness of that luminaire) or as an absolute value (e.g. a specific output brightness in lumens). This applies to both the input and the output. Whether a percentage or an absolute value is used may depend on the particular lighting system. Additionally, different luminaires within the lighting system may use different methods, e.g. a percentage lighting setting modifier may be applied to one luminaire and an absolute lighting setting modifier may be applied to another luminaire within the same lighting system. With an absolute value the equalization can be better with different light types but may limit high lumen lights to the capabilities of lower lumen lights.

The lighting function may also be called a lighting mask, vector, matrix, array, or equaliser, and may define the lighting setting modifiers either individually by means of a vector or matrix (i.e. of individual set values), or analytically by means of an analytical function (i.e. a distribution such as a curve) which at different points defines respective modifier values for the multiple light setting modifiers.

Note that the lighting function may be linear or non-linear and may include variables other than user set lighting modifiers. These variables can be anything related to the script/light effect itself (light pattern).

For example, properties of the specific colours of a scene. This means that the lighting function depends on the colours themselves in the scene to be rendered. In this case the lighting function can depend on: specific colors in a palette of the scene, in which case the brightnesses of the luminaires can be adapted differently depending on the color (e.g. red results in a higher multiplication factor then blue); and/or saturation, in which case brightnesses of the luminaires can be adapted differently depending on the saturation (e.g. the less saturated colors have a lower multiplication factor applied than fully saturated colors.

Further variables can include the type of the effect that is being rendered. For example: specific values or parameters that are provided in the script itself (where for example a script creator can explicitly indicate the function or some parameters of the brightness function); number and/or type of lights on which the effect is being rendered (e.g. LED luminaires have a higher multiplication factor applied to their settings than incandescent bulbs); and/or light level in the room (e.g. if the user has for example hue motion sensor in the room that also includes light level sensor).

In any case, the lighting function, as stored in memory, specifies the respective lighting setting modifiers for all the multiple different luminaires to be modified at once, i.e. it defines the modification for all the luminaires in question as a whole at a given time. Hence the lighting function can be considered as a mask or layer that is applied across the set of differently positioned luminaires as a whole simultaneously. In the case where the lighting function comprises a set of individual respective modifiers values for the set of luminaires to be modified, this means all the individual modifier values are stored simultaneously in memory. In the case of an analytical function (i.e. formula), then the formula, as stored in the memory, at once defines the respective modifiers for all the luminaires in the set. For example, the lighting function may explicitly indicate the lighting setting modifier for each lighting setting. The lighting function may be a mathematical formula which allows the lighting setting modifier for a given lighting setting to be calculated. For example, the lighting function may be considered a “field” throughout the environment defining a lighting setting modifier for each spatial point. As mentioned above, the lighting setting modifiers may be scalar (e.g. a multiplication factor) or a vector (e.g. separate RGB modifiers) in which case it is appreciated that the lighting function may be either a scalar or vector field over space within the environment. It is appreciated, based on the above, that the lighting function may be continuous (e.g. as in the case of a field) or discrete (e.g. as in the case of explicit indications). It is also appreciated that the lighting function may be a 2D or 3D spatial array of lighting setting modifiers. This is particularly advantageous is the plurality of luminaires to be controller within the environment form a 2D or 3D array (respectively), as each luminaire can be associated with a respective lighting setting modifier in the corresponding array.

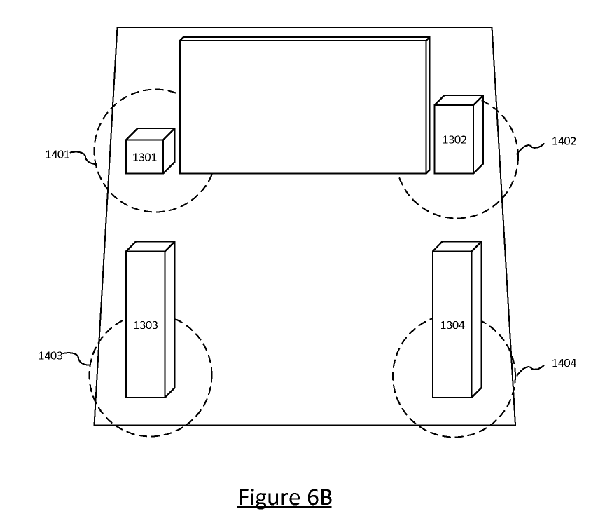

The lighting function permits a mapping between lighting setting modifiers and lighting settings for luminaires. The lighting function may define lighting setting modifiers for particular luminaires explicitly (e.g. by defining each lighting setting modifier in association with an identification of a luminaire such as a serial number or address on the network). Alternatively, the lighting function may define lighting setting modifiers for different regions within an environment (see FIG. 6B described below). The corresponding lighting setting modifier for each luminaire can then be determined in one of two ways. Firstly, the lighting setting modifier for a given luminaire can simply be the lighting setting modifier for the region in which the luminaire is physically located. Secondly, the lighting setting modifier for a given luminaire can be the lighting setting modifier for the region in which the luminaire casts a lighting effect. The location of the luminaire itself can be known to the system through known methods such as a positioning network or through a commissioning process. Equivalently, the location of the light effect of each luminaire can be known through known methods such as a commissioning process or more advanced techniques such as capturing an image of the environment while each luminaire is rendering a lighting effect with a unique embedded coded light code.

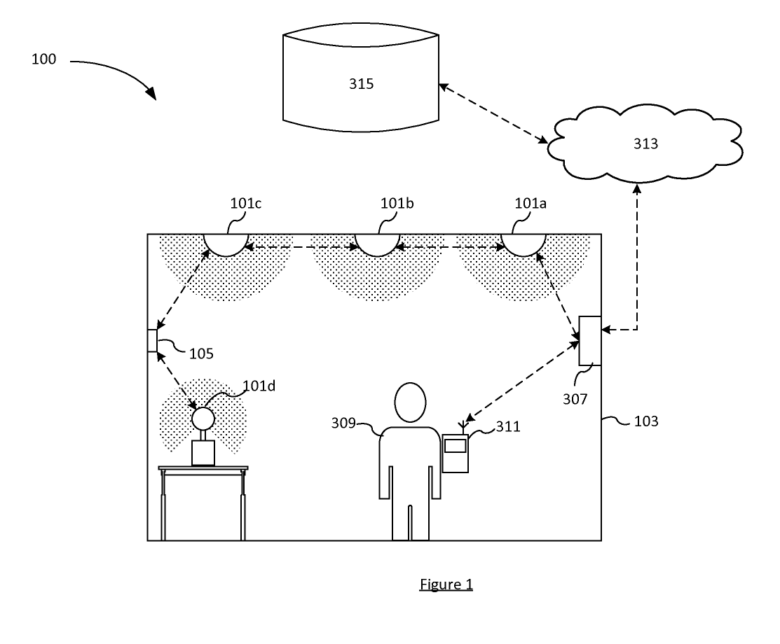

FIG. 1 shows a system 100 according to embodiments of the present invention. An environment 103 contains a plurality of luminaires 101a-d and a switch 105. Luminaires 101a-c are ceiling type luminaires designed to provide illumination in the environment 103 from above. Luminaire 101d is a free-standing lamp type luminaire placed on a table designed to provide illumination in the environment 103 from a lower position than the ceiling type luminaires 101a-c. Each of the luminaires 101a-d may be any suitable type of luminaire such as an incandescent light, a fluorescent light, an LED lighting device etc. The plurality of luminaires 101a-d may comprise more than one type of luminaire, or each luminaire 101a-d maybe of the same type.

The switch 105 is shown in FIG. 1 as a wall-mounted switch and may be any suitable type of switch allowing user input to control the plurality of luminaires 101a-d. For example, the switch 105 maybe a simple on-off controller switch or may allow for more complex control such as dimming and possibly even control of individual lighting characteristics such as hue and saturation. The switch 105 is part of the lighting system in that the switch 105 is able to send data to and receive data from the other elements in the lighting system. Particularly, the switch 105 is able to access a shared memory of the lighting system (e.g. memory 315, described later).

The plurality of luminaires 101a-d, and the switch 105, along with a lighting bridge 307 form a connected lighting network. That is, they are all interconnected by wired and/or wireless connections, indicated by dotted lines in FIG. 1. In particular, FIG. 1 shows “chaining” connections such as may be implemented in a ZigBee lighting network, wherein it is not necessary for each device to be directly connected to each other device. Instead, devices are able to relay communication signals which allows for, for example, luminaire 101c to communicate with the lighting bridge 307 by relaying data through luminaires 101b and 101a to lighting bridge 307. However, it is not excluded that other network topologies may be employed. For example, a “hub-and-spoke” topology may be used in which each device is directly connected (e.g. wirelessly) to the lighting bridge 307 and not to any other devices in the network.

As another example, each luminaire in the network may be configured according to one communication protocol, such as ZigBee, and the switches may be configured according to another communication protocol, such as WiFi. Hence, it is appreciated that the luminaires may communicate with each other and the lighting bridge 307 without relaying data through a switch as shown in FIG. 1, and the switch 105 may communicate directly with the lighting bridge 307. In any case, it is understood that the lighting bridge 307 is able to communicate, by whatever appropriate means, with each other device in the lighting network.

Lighting bridge 307 is arranged at least to receive input (e.g. from switch 105 or user device 311) and to send lighting control commands to luminaires 101a-d.

FIG. 1 also shows a user 309 and user device 311. For example, the user device 311 may take the form of a mobile user device such as a smart phone, tablet or laptop; or a static user device such as a desktop computer. The user device 311 is operatively coupled to the lighting bridge 307 by a wired or wireless connection (e.g. WiFi or ZigBee) and hence forms part of the lighting network. User 309 can provide user input to the lighting bridge 307 via the user device 311 using, for example, a graphical user interface of the user device 311. The lighting bridge 307 then interprets the user input and sends control commands to the luminaires 101a-d accordingly. As mentioned above, the user device 311 generally allows for more complex control than the switch 105. For example, the user 309 may use the user device 311 to control an individual luminaire. The user device 311 may be used to control the plurality of luminaires to render a lighting scene, e.g. by the user 309 selecting the lighting scene and desired luminaires using a GUI of the user device 311.

The system 100 also comprises a memory 315 in which the lighting modification function (i.e. the equalizer function) is stored. As mentioned, this lighting function, as stored in the memory 315 at a given point in time, at once defines multiple respective modifiers to be applied to the lighting settings of a set of multiple difference ones of the luminaires 101a-d. The memory 315 in which this lighting function is stored may comprise remote storage on a server (comprising one or more server units at one or more geographical sites) or a local memory on the user device 311, or a combination of these.

As illustrated in FIG. 1, lighting bridge 307 may also be provided with a wide area network (WAN) connection such as a connection to the internet 313. This connection, as known in the art, allows the lighting bridge 307 to connect to external data and services such as the memory 315. Note that the wireless connection between user device 311 and the lighting bridge 307 is shown in FIG. 1 as a direct connection, but it is understood that the user device 311 may also connect to the lighting bridge 307 via the internet 313.

In operation, the plurality of luminaires 101a-d are arranged to render a lighting scene. User 309 may have controlled the luminaires 101a-d via the lighting bridge 307 using his user device 301 (or by switch 105) to render the lighting scene, or the lighting scene may have been automatically triggered by, for example, detection of the presence of user 309 by a presence sensor (not shown), by a timer, or by an external event or trigger e.g. from a cloud-based server from other services such as a trigger based on local meteorological data.

In the present invention, when the user 309 implements a lighting pattern (also called a lighting “scene), e.g. via input through his smartphone 311, the system determines the desired scene to be rendered, which consists of lighting settings for each luminaire, and first applies a lighting function to the lighting pattern which alters one or more of the lighting settings before they are sent to the luminaires for rendering. The lighting pattern may be selected by the user 309, selected by another user other than user 309, or automatically selected by the system (e.g. a default lighting pattern).

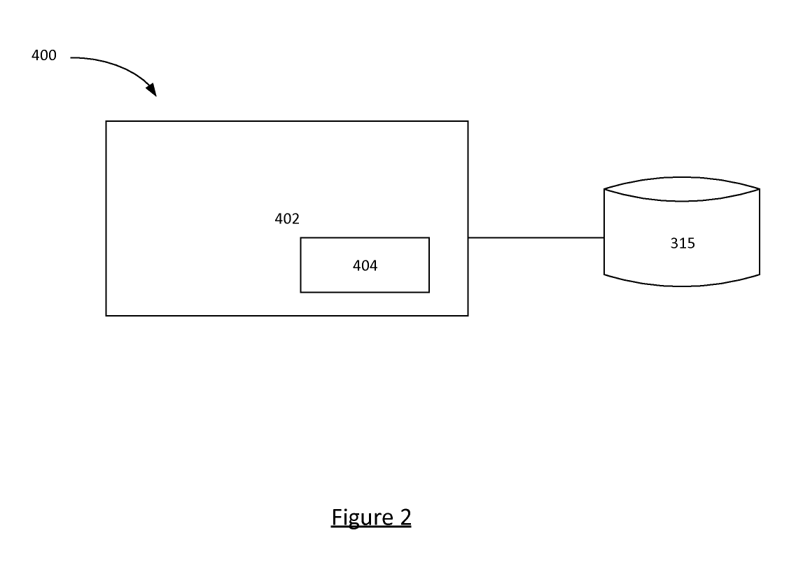

FIG. 2 shows a functional block diagram of a controller 400. The controller 400 is a functional block providing the functionality described herein, and the controller 400 may be implemented solely in hardware, software, or in a combination of hardware and software. Hence, it is understood that FIG. 2 is for the purposes of illustration only. FIG. 2 shows the controller 400 as comprising code 404 running on at least one processor 402. That is, it is understood that the controller 400 shown in FIG. 2 represent a functional block which is implemented in the lighting system 100 shown in FIG. 1. For example, the controller 400 maybe implemented in the lighting bridge 307, one of the plurality of luminaires 101a-d, the switch 105, or the user device 311. It is also understood that the controller 400 maybe implemented in a distributed manner with some functionality being implemented in one entity of the lighting system (as mentioned above) and other functionality implemented in one or more other entities of the lighting system.

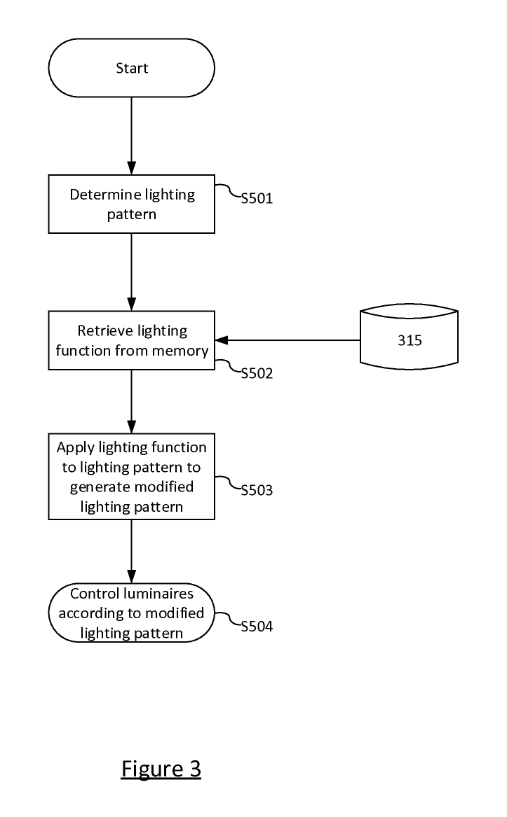

FIG. 3 is a flow diagram of a method implemented by the controller 400 in accordance with embodiments of the present invention.

The method begins at step S501 by determining a lighting pattern to be rendered by the plurality of luminaires 101a-d. The lighting pattern comprises a respective lighting setting for transmission to each of the plurality of luminaires 101a-d.

At step S502, the controller 400 accesses a memory (such as memory 315) to retrieve a lighting function. The memory 315 stores the lighting function which defines concurrently for a set of some or all of said plurality of luminaires respective lighting setting modifiers to be applied to the respective lighting settings for the respective luminaires in the set. At least some of the defined lighting setting modifiers of the lighting function are different.

At step S503, the controller 400 applies the lighting function to the lighting pattern to generate a modified lighting pattern comprising respective modified lighting settings for the plurality of luminaires, by applying the lighting setting modifiers to the respective lighting settings in order to generate the respective modified lighting settings for said luminaires of said set.

At step S504, the controller controls the plurality of luminaires 101a-d to render the modified lighting pattern, by controlling the luminaires of said set in accordance with the respective modified lighting settings and controlling other ones of said plurality of luminaires not in said set in accordance with the respective lighting setting.

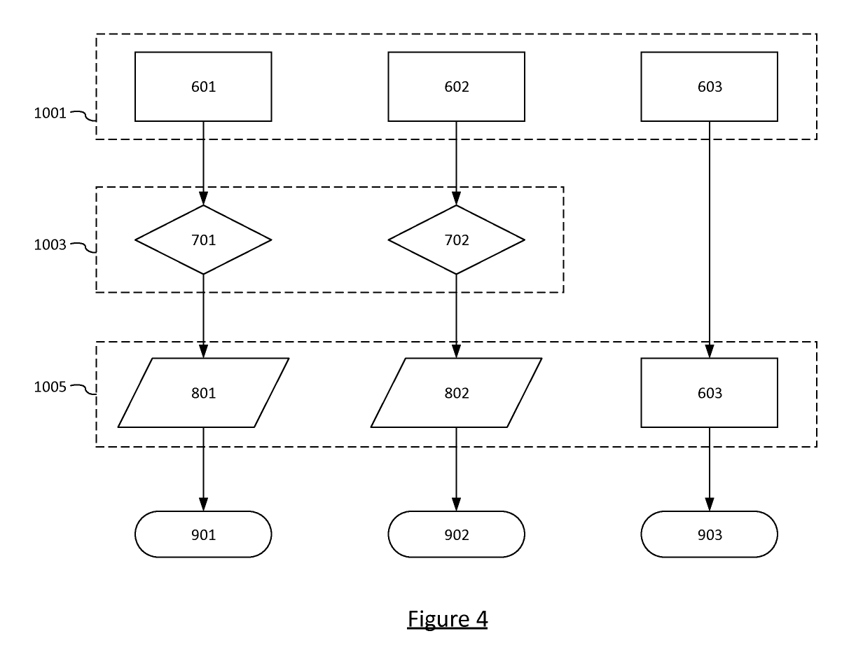

FIG. 4 shows an exemplary diagram of a method according to embodiments of the present invention. In this example, there are three luminaires 901-903. A lighting pattern 1001 consists of a respective lighting setting for each luminaire, in this case lighting settings 601, 602, and 603 which are for rendering by luminaires 901, 902 and 902, respectively. In prior art systems, the lighting settings 601-603 would be transmitted to the respective luminaire 901-903 and the luminaires would adapt their light output based on the received lighting setting in order to render the lighting pattern 1001 within an environment. In the present invention, however, a lighting function 1003 is first applied to the lighting pattern 1001.

The lighting function 1003 comprises lighting modifiers which alter the lighting settings in some way. In the example shown in FIG. 4 there are two lighting setting modifiers 701, 702 in the lighting function 1003. It is understood that more or fewer lighting setting modifiers maybe used. That is, the lighting function 1003 in general comprises lighting setting modifiers for some or all of the lighting settings.

The lighting function 1003 is applied to the lighting pattern 1001 in order to generate a modified lighting pattern 1005. In the example of FIG. 4, this comprises applying lighting setting modifiers 701 and 702 to lighting settings 601 and 602, respectively. Note that no lighting setting modifier is applied to lighting setting 603. Equivalently, the lighting function 1003 may contain a “null” lighting modifier with respect to lighting setting 603 which does not alter lighting setting 603. In either case, the modified lighting pattern 1005 comprises modified lighting setting 801, modified lighting setting 802, and lighting setting 603 (which has not been modified, either because no lighting modifier was applied to it or because a “null” modifier was applied).

The respective lighting settings of the modified lighting pattern 1005 are then sent to the respective luminaires such that the modified lighting pattern 1005 is rendered by the luminaires 901-903.

In general, the lighting system 100 will consist of different light types which are also placed differently, resulting in different perceived intensity changes. For example: a LED strip of 2 meters at 800 lumen vs. a bulb at 800 lumen; or a lamp in direct light of sight vs indirect lighting. This results in varying light intensities as perceived by the user 309. Hence, in embodiments the controller 400 takes into account perceived light intensity of the light emitted by the lamps. These properties can be known to the controller 400, for example, by being pre-determined in a commissioning step and stored to memory such as memory 315. Alternatively, the controller 400 may obtain the actual effects each luminaire has on the environment 101, rather than just a commissioned value. This can be done, for example, by having the user 309 initiate a preset (possibly dynamic) lighting effect and capturing a video when the lights are generating the effects. This video can then be processed at the user's smartphone 311 or transmitted to the controller 400 for processing. Such processing allows the controller 400 to determine an appropriate lighting function for the environment 100. For example, based on such data, the controller 400 can create a recommended intensity profile which equalizes the lighting in the room. For example, if the preset lighting pattern comprised an equal lighting brightness for each luminaire, and the controller 400 is able to determine the specific luminaire which is the source of each bright spot in the captured video (e.g. via having each luminaire emit light with a different coded light signal, as known in the art), then the controller 400 can determine the relative brightnesses of each luminaire and determine the lighting function accordingly. For example, if the controller 400 determines that luminaires 101a-d have perceived intensities of [40%, 80%, 80%, 80%], respectively, then an appropriate lighting function would be brightness multiplication factors [2, 1, 1, 1], respectively as this would “equalize” the perceived brightnesses of the luminaires, automatically creating a good default profile which can still be tuned by the user if really needed.

In general, whether determined automatically (e.g. via a video) or manually (e.g. during a commissioning phase), if the controller 400 has access to the relative perceived brightness of each luminaire, it can take them into account when calculating the lighting modifiers for the lighting function.

The application (e.g. an entertainment application, as described above) generating the generic, i.e. unmodified, lighting settings may also be arranged to take intensity settings directly into account. That is, the controller 400 may be implemented as part of the application itself, e.g. functionality described herein as attributed to the controller 400 maybe provided by the application directly. In these cases, instead of the system modifying the lighting settings after they has been created by the entertainment application, the application can do this automatically before the lighting settings are transmitted by the application. The application is notified about the current intensity distribution and can make specialized algorithms to do the light intensity adjustment, as described herein with reference to the controller 400.

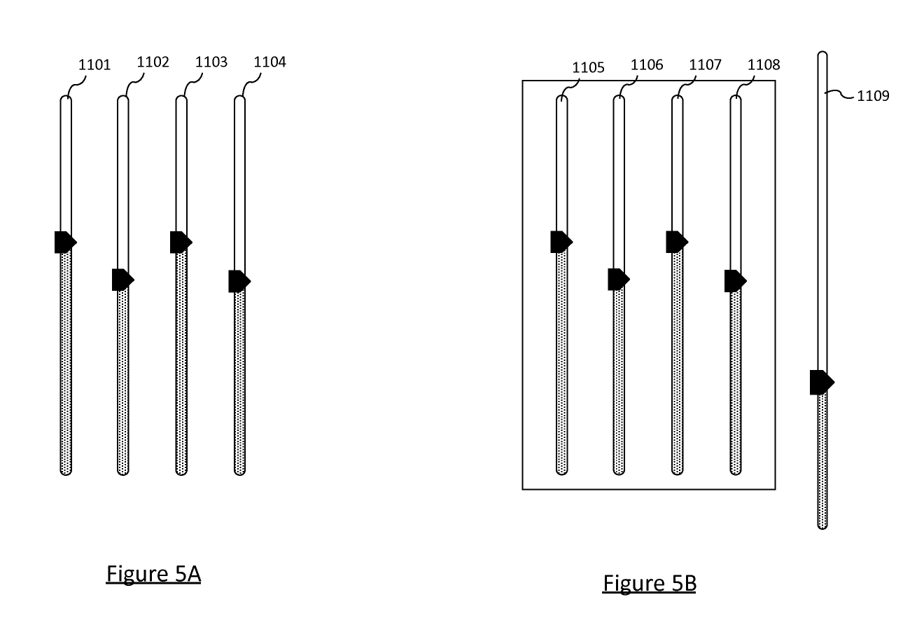

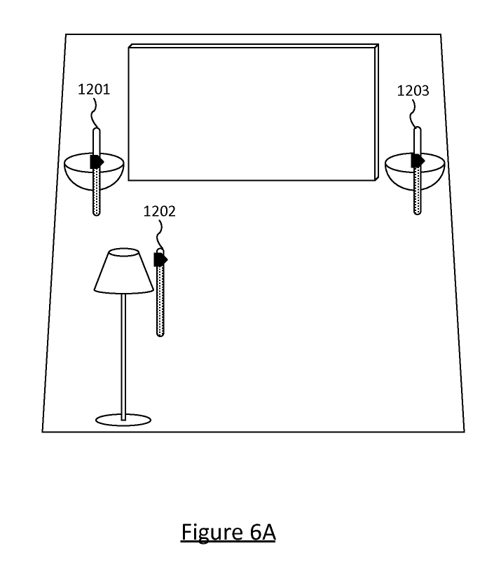

FIGS. 5A-B and 6A-6B show examples of graphical user interface (GUIs) which may be implemented to allow the user 309 to edit the lighting function 1003 via his user device 311. The UI for the control can be a simple set of sliders as shown in FIGS. 5A-5B, or could be more complicated such as the representation of a room shown in FIGS. 6A-6B.

In FIG. 5A, the user 309 is provided with a slider 1101-1104 for each luminaire (e.g. luminaires 101a-d). Each slider allows the user to control the lighting setting modifier of the lighting function which will be applied to the respective lighting setting for the respective luminaire. For example, in FIG. 5A the user has set sliders 1101 and 1103 to be higher than sliders 1102 and 1104. This may correspond to a higher brightness multiplication factor for luminaires 101a and 101c then for luminaires 101b and 101d. The UI might also offer a master control 1109 as shown in FIG. 5B. In this example, the user is still provided with individual sliders 1105-1108, as before, but is also able to adjust the overall intensity/brightness using master slider 1109. I.e. the master slider 1109 simultaneously adjusts the positions of the sliders 1105-1108 such that the relative relation between the intensities remains the same.

In embodiments, the master control can also be automatic. For example, the controller 400 may set the position of the master slider 1009 based on a reading from a light sensor located in the personal devices of the user, in a TV or lamp itself. In this case the user 309 can define the relative intensity levels per luminaire while the master level is controlled by the sensors, e.g. if the room is very bright the overall level might go up and vice versa.

FIGS. 6A and 6B illustrate different approaches to the definition of the lighting function. In FIG. 6A, the lighting function defines a lighting setting modifier (illustrated by sliders 1201-1203) for each luminaire, whereas in FIG. 6B the lighting function defines a lighting setting modifier (illustrated by bars 1301-1304) for different areas 1401-1404 within the environment. The first case (FIG. 6A) is simple in that the lighting setting modifiers are defined per luminaire and therefore the controller 400 is able to determine which lighting modifier to apply to which lighting setting (as the lighting modifier and lighting setting are both associated with the same luminaire). In the second case (FIG. 6B), the controller 400 must determine the location of a luminaire in order to determine which lighting setting modifier is to be applied to the lighting setting for that luminaire. This can be done, for example, in a commissioning step in which a commissioner notes the location of each luminaire within the environment (e.g. latitude/longitude) and stores this information to memory (e.g. memory 315). This allows the controller 400 to determine which area 1401-1404 a given luminaire is in and therefore which lighting setting modifier is to be applied.

However, the lighting function is defined, it is understood based on the above that the user is able to create different lighting functions. These functions may be stored to memory 315 for later use. For example, the user 309 may store multiple lighting functions which can be accessed at later points in time for implementation by the controller 400. This is particularly advantageous because the equalization profile (lighting function) desired by the user may vary depending on e.g. a type of game he is playing, time of day, his mood etc.

The lighting function may be defined in parts. For example, the lighting function may comprise a first part defining lighting setting modifiers for a respective first set of the luminaires, and a second part defining lighting setting modifiers for a respective second set of the luminaires which does not overlap with the first set (i.e. no luminaire is in both the first and second set). There maybe more than two parts to the lighting function. This is particularly advantageous as the parts of the lighting function may be selected and configured separately by different users.

The following is an example scenario with the intention of making the advantages of the present invention clear. In this scenario, a user wants to play a game using his home lighting setup. He noticed that the lights next to the television are too bright and directly shining in his eye, making it a bad experience. Also, effects on the wall lights on his left are hardly noticeable because they are overshadowed by intense effects from his main ceiling lights in the center of the room. Last, he has a personal preference for the light effects behind him to be very bright so it's easy to notice what happens outside his line of sight. He now simply opens the light equalizer UI where he can in three dimensions adjust the intensity of the light effects for a certain location. He will drag/pull/move the front intensity far down, the center intensity a bit down, the left intensity a bit up and the back intensity far up. When he now goes on playing the game, the light effects are nicely equalized to his setup and preferences, giving a good experience. The configuration is saved to the system so he can also use it for other games he plays.

It will be appreciated that the above embodiments have been described only by way of example. Other variations to the disclosed embodiments can be understood and effected by those skilled in the art in practicing the claimed invention, from a study of the drawings, the disclosure, and the appended claims.

As a first example, lighting patterns (especially dynamic lighting patterns) often consist of different layers, such a “background ambience” layer and a “sudden effects” layer which are particularly useful for entertainment lighting patterns, e.g. a lighting pattern accompanying a movie a user is watching on a TV. The background ambience is a layer providing background lighting which is always present (e.g. static lighting, or dynamic lighting slowly varying overtime). The sudden effects layer is a layer of temporary, often significant, effects which override the background layer. The present invention may be applied to systems using layered lighting. For example, the lighting function can define different respective lighting modifiers for each layer separately. This means the adjustment should be done before the layers are being merged. There are many ways to do this. For example, the layers can have different priorities, e.g. the sudden effects layer has a higher priority than (“comes on top of”) the ambiance layer. Each layer may also have a transparency value for the layer as a whole or for each colour setting individually e.g. using an Alpha channel (RGBA instead of just RGB) where Alpha (α) defines the transparency for a color between 0-1. Then, the lowest layer A and next level layer B are merged as αA+(1−α)B using the alpha values from layer B (the lowest layer alpha is essentially ignored). This resulting merged layer is then merged in the same with the next level layer etc. If the highest layer is fully opaque (α=0) the layers below will be entirely hidden, but the more transparent, the more mixing.

As a second example, the present invention can be extended to take into account the intensities of other sources like the dynamic range of smart TV. In this case, there are one or more sources of illumination within the environment which are not part of the lighting system itself (i.e. not wired or wirelessly connected to the controller 400). These non-connected illumination sources still affect the lighting atmosphere within the environment even though they are not directly controlled by the controller 400 to render the lighting pattern. Hence, the system maybe extended by the inclusion of one or more sensors within the environment arranged to detect the lighting effect of such non-connected sources. This may be done directly, via one or more photosensors, or through other means such as determining by the controller 400 the settings of the non-connected sources and inferring the lighting effect of the sources. Note that in the latter case the non-connected sources are still “non-connected” in the sense that the controller 400 does not control them, even though the controller 400 may be able to receive information regarding their settings via a wired or wireless means. In either case, the controller 400 is able to take into account light intensity of the sources which are not directly part of the connected lighting system.

A particularly ubiquitous example of such a non-connected source is a TV. In this case, the above-described extension is particularly advantageous because the dynamic range and brightness of a TV set varies depending on the model, user settings, and content playing. Similarly for the lamps depending on the type different levels of brightness both high and low might be achieved. If lamps play light effects too bright comparing to the TV brightness than they might become distracting, while if the brightness is to low compared to the brightness of the TV they might not have the desired effect.

If the TV is a smart TV, the dynamic range of the TV can be adapted as if it's ‘just another light’ on a certain location. In this case, the TV is another source of light within the environment other than the plurality of luminaires. As mentioned above, the term “luminaire” refers to light sources which are designed to provide illumination within an environment. A TV, on the other hand, it not a luminaire but may still contribute to the lighting within an environment despite its primary purpose not being illumination. Alternatively, the dynamic range of lamps used in the entertainment setup can be adapted. This adaption can be done based on brightness and dynamic range of the TV (display), combined with the type of content played on the screen and location of lamps relative to the TV.

The brightness and dynamic range of the TV can be either directly received from the TV in case if it's a connected TV or Smart TV or measured using light sensor (camera) of the personal smart device. Then the dynamic range for the lamps can be adjusted accordingly to fit into that range. Depending on the setup brightness boundaries can be applied directly to lamps e.g. using setting in the bridge. Alternatively more smart adjustment can be done if a light script is used to create light effects to accompany a movie or a game, in such a case the light script rendering engine could analyze the script and adjust brightness such that effects played are not distorted too much. Such dynamic range adaptation can be done once as a part of the setup, or can be dynamic so that environmental light level is also taken into account.

In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored and/or distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A method of controlling a plurality of luminaires to illuminate an environment, the method comprising steps of:
providing a user with a slider for each of the plurality of luminaires, each slider allowing the user to control a lighting setting modifier, comprising a brightness multiplication factor, which is to be applied to the respective luminaire, thereby creating an equalization profile wherein at least some of the defined lighting setting modifiers are different;
storing the equalization profile in a memory;
determining, based on received generic light control input, a lighting pattern to be rendered by the plurality of luminaires, the lighting patter comprising a respective lighting setting for transmission to each of the plurality of luminaires;
retrieving from the memory the equalization profile, selected by the user, which, as stored in the memory, defines concurrently for all of said plurality of luminaires respective lighting setting modifiers to be applied to the respective lighting settings for the respective luminaires;
applying the equalization profile to the lighting pattern to generate adjusted light control output comprising respective modified lighting settings for the plurality of luminaires, by,
applying each lighting setting modifier to the respective lighting settings in order to generate the respective modified lighting settings for said luminaires; and
controlling the plurality of luminaires to render the adjusted light control output instead of the generic light control input, by controlling the luminaires in accordance with the respective modified lighting settings.

2. The method according to claim 1, wherein the equalization profile is stored in the memory concurrently defining the respective lighting setting modifiers for luminaires before the lighting pattern is determined.

3. The method according to claim 1, wherein the equalization profile comprises a first part defining lighting setting modifiers for a first set of the plurality of luminaires and a second part defining lighting setting modifiers for a second set of the plurality of luminaires, said second set non-overlapping with the first set; wherein the method further comprises:
the user selecting the first part of the equalization profile and the first set of the plurality of luminaires; and
selecting the second part of the lighting function and the second set of the plurality of luminaires.

4. The method according to claim 1, wherein the equalization profile is determined based on user input received from the user, and wherein the respective lighting setting modifiers of said lighting function are defined by a different user other than said user.

5. The method according to claim 1, wherein the lighting pattern is determined by being retrieved from a memory storing the lighting pattern.

6. The method according to claim 1, further comprising steps of:
determining a second lighting pattern to be rendered by the plurality of luminaires;
applying the same equalization profile to the second lighting pattern to generate a modified second lighting pattern; and
controlling the plurality of luminaires to render the modified second lighting pattern.

7. (canceled)

8. (canceled)

9. A controller for controlling a plurality of luminaires to illuminate an environment, the controller comprising a processor arranged to:
provide a user with a slider for each of the plurality of luminaires, each slider allowing the user to control a lighting setting modifier, comprising a brightness multiplication factor, which is to be applied to the respective luminaire, thereby creating an equalization profile wherein at least some of the defined lighting setting modifiers are different;
store the equalization profile in a memory;
determine, based on received generic light control input, a lighting pattern to be rendered by the plurality of luminaires, the lighting pattern comprising a respective lighting setting for transmission to each of the plurality of luminaires;
retrieve from the memory storing the equalization profile, selected by the user, which, as stored in the memory, defines concurrently for all of said plurality of luminaires respective lighting setting modifiers to be applied to the respective lighting settings for the respective luminaires;
apply the equalization profile to the lighting pattern to generate adjusted light control output comprising respective modified lighting settings for the plurality of luminaires, by
applying each lighting setting modifier to the respective lighting settings in order to generate the respective modified lighting settings for said luminaires; and
control the plurality of luminaires to render the adjusted light control output instead of the generic light control input, by controlling the luminaires in accordance with the respective modified lighting settings.

10. A system comprising the controller according to claim 9 and the plurality of luminaires.

11. A computer program product comprising code stored on a computer-readable storage medium arranged so as when executed by one or more processing units to perform the method according to claim 9.
